(19) United States
(12) Patent Application Publication
(10) Pub. No.: US 2025/0105475 A1
(43) Pub. Date: Mar. 27, 2025

(54) SPUTTERED INSULATIVE SURFACE COATING FOR USE IN ELECTROCHEMICAL CELLS

(71) Applicant: Cardiac Pacemakers, Inc., St. Paul, MN (US)

(72) Inventors: Troy Anthony Giese, Blaine, MN (US); Matthew P. Jones, Shoreview, MN (US); Sverre Gropen, Minneapolis, MN (US); Larry Michael Killeen, Elk River, MN (US); Brent Jason Gerten, Lino Lakes, MN (US)

(21) Appl. No.: 18/825,518

(22) Filed: Sep. 5, 2024

Related U.S. Application Data
(60) Provisional application No. 63/540,168, filed on Sep. 25, 2023.

(51) Int. Cl. H01M 50/562; H01M 50/564

(52) U.S. Cl. CPC H01M 50/562; H01M 50/564

(57) ABSTRACT

A battery can include an anode and a cathode enclosed within a battery housing, a feedthrough terminal coupled to one of the anode or the cathode and extending through a lid of the battery housing, and a glass insulator between the feedthrough terminal and the lid, wherein an outside surface of the lid and an outer surface of the feedthrough terminal and an outer surface of the glass insulator is covered by a first layer of an electrically insulative coating.

### CLAIM OF PRIORITY

This application claims the benefit of U.S. Provisional Application No. 63/540,168, filed on Sep. 25, 2023, which is hereby incorporated by reference in its entirety.

### TECHNICAL FIELD

Various embodiments described herein relate to apparatus, systems, and methods associated with implantable medical devices.

### BACKGROUND

An ambulatory medical device, such as an implantable medical device (IMD), can be configured for implant in a subject, such as a patient. An IMD can be configured to be coupled to a patient's heart such as via one or more implantable leads. Such an IMD can obtain diagnostic information or generate therapy to be provided to the patient, such as via the coupled implantable lead.

In one configuration, IMDs have a header that is coupled to a housing that houses much of the electronics, including batteries, of the IMD. The reliability of batteries is a concern. Moreover, implantable medical devices are getting smaller, which drives a need for a higher energy density primary battery cell. Inactive components within the battery reduce energy density, so there is a clear benefit to reducing that volume.

### SUMMARY

Example 1 can include subject matter such as a battery. The battery can include an anode and a cathode enclosed within a battery housing, a feedthrough terminal coupled to one of the anode or the cathode and extending through a lid of the battery housing, and a glass insulator between the feedthrough terminal and the lid; wherein an outside surface of the lid and an outer surface of the feedthrough terminal and an outer surface of the glass insulator is covered by a first layer of an electrically insulative coating.

In Example 2, the subject matter of Example 1 can optionally include at least a portion of an inner surface of the lid and an inner surface of the glass insulator being covered by a second layer of an electrically insulative coating.

In Example 3, the subject matter of any one or more of Examples 1-2 can optionally include a polyimide tape being positioned over the glass insulator and the portion of inside surface of the lid around the glass insulator.

In Example 4, the subject matter of any one or more of Examples 1-3 can optionally include the second electrically insulative coating being positioned and configured to prevent lithium clusters within the battery housing.

In Example 5, the subject matter of any one or more of Examples 1-4 can optionally include the first layer of the electrically insulative coating being a sputtered layer of aluminum oxide.

In Example 6, the subject matter of any one or more of Examples 1-5 can optionally include a polyimide tape positioned over the glass insulator and a portion of outside surface of the lid around the glass insulator.

In Example 7, the subject matter of any one or more of Examples 1-6 can optionally include a solder sleeve welded to the outer surface of the feedthrough terminal over the first layer of the electrically insulative coating.

In Example 8, the subject matter of any one or more of Examples 1-7 can optionally include the first layer of electrically insulative coating being positioned and configured to prevent corrosion of the outer surface of the feedthrough terminal and prevent any solder bridges from forming between the solder sleeve and the lid by providing electrical insulation beneath the polyimide tape between the solder sleeve and the lid.

In Example 9, the subject matter of any one or more of Examples 1-8 can optionally include the battery housing being filled with an electrolyte.

In Example 10, the subject matter of any one or more of Examples 1-9 can optionally include the feedthrough terminal including molybdenum.

Example 11 can include an apparatus that can include an implantable housing holding electronics, a battery located within the implantable housing, the battery including an anode and a cathode enclosed within a battery housing, a feedthrough terminal coupled to one of the anode or the cathode and extending through a lid of the battery housing, and a glass insulator between the feedthrough terminal and the lid, wherein at least a portion of an outside surface of the lid and an outer surface of the feedthrough terminal and an outer surface of the glass insulator are covered by a first layer of an electrically insulative coating, and wherein at least a portion of an inner surface of the lid and an inner surface of the glass insulator are covered by a second layer of the electrically insulative coating.

In Example 12, the subject matter of any one or more of Examples 1-11 can optionally include a polyimide tape being positioned over the glass insulator and the portion of inside surface of the lid around the glass insulator.

In Example 13, the subject matter of any one or more of Examples 1-12 can optionally include the second layer of the electrically insulative coating being positioned and configured to prevent lithium clusters within the battery housing.

In Example 14, the subject matter of any one or more of Examples 1-13 can optionally include the first and second layers of the electrically insulative coating each including a sputtered layer of aluminum oxide.

In Example 15, the subject matter of any one or more of Examples 1-14 can optionally include a polyimide tape positioned over the glass insulator and a portion of outside surface of the lid around the glass insulator.

In Example 16, the subject matter of any one or more of Examples 1-15 can optionally include a solder sleeve welded to the outer surface of the feedthrough terminal over the first layer of the electrically insulative coating.

In Example 17, the subject matter of any one or more of Examples 1-16 can optionally include the first layer of electrically insulative coating being positioned and configured to prevent corrosion of the outer surface of the feedthrough terminal and prevent any solder bridges from forming between the solder sleeve and the lid by providing electrical insulation beneath the polyimide tape between the solder sleeve and the lid.

Example 18 can include subject matter such as a method including providing a lid for a battery housing, the lid including a feedthrough terminal extending through a lid, and a glass insulator between the feedthrough terminal and the lid; sputtering a first layer of an electrically insulative coating onto at least a portion of an outside surface of the lid and an outer surface of the feedthrough terminal and an outer surface of the glass insulator; and sputtering a second layer of the electrically insulative coating on at least a portion of an inner surface of the lid and an inner surface of the glass insulator.

In Example 19, the subject matter of any one or more of Examples 1-18 can optionally include the first layer of electrically insulative coating being positioned and configured to prevent corrosion of the outer surface of the feedthrough terminal and prevent any solder bridges from forming between a solder sleeve over the feedthrough terminal and the lid by providing electrical insulation beneath a polyimide between the solder sleeve and the lid, and the second electrically insulative coating being positioned and configured to prevent lithium clusters within a battery housing enclosed by the lid.

In Example 20, the subject matter of any one or more of Examples 1-19 can optionally include the first layer and the second layer of electrically insulative coating including a <5 μm layer of sputtered aluminum oxide.

In Example 21, subject matter (e.g., a system or apparatus) may optionally combine any portion or combination of any portion of any one or more of Examples 1-20 to comprise “means for” performing any portion of any one or more of the functions or methods of Examples 1-20, or at least one “non-transitory machine-readable medium” including instructions that, when performed by a machine, cause the machine to perform any portion of any one or more of the functions or methods of Examples 1-20.

This summary is intended to provide an overview of subject matter of the present patent application. It is not intended to provide an exclusive or exhaustive explanation of the disclosure. The detailed description is included to provide further information about the present patent application. Other aspects of the disclosure will be apparent to persons skilled in the art upon reading and understanding the following detailed description and viewing the drawings that form a part thereof, each of which are not to be taken in a limiting sense.

### BRIEF DESCRIPTION OF THE DRAWINGS

FIG. 1 shows an example implantable medical device, in accordance with one embodiment.

FIG. 2 shows a side view of a battery, in accordance with one embodiment.

FIG. 3 shows a cross-section view of a lid of the battery, in accordance with one embodiment.

FIG. 4 shows a top perspective view of the lid of the battery, in accordance with one embodiment.

FIG. 5 shows a top perspective view of the lid of the battery, in accordance with one embodiment.

FIG. 6 shows a bottom perspective view of the lid of the battery, in accordance with one embodiment.

FIG. 7 shows a method of manufacturing a battery, in accordance with one embodiment.

### DETAILED DESCRIPTION

In the following detailed description, reference is made to the accompanying drawings that form a part hereof and in which are shown, by way of illustration, specific embodiments in which the invention may be practiced. These embodiments are described in sufficient detail to enable those skilled in the art to practice the invention. Other embodiments may be utilized and structural, logical, and electrical changes may be made.

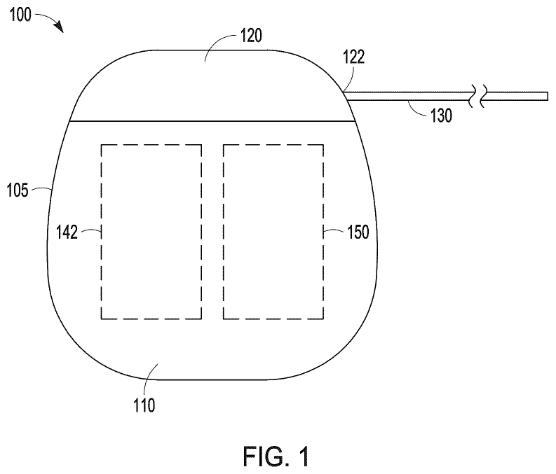

FIG. 1 shows an implantable medical device 100 in accordance with one example. The implantable medical device 100 includes a pulse generator 105 including a metallic housing 110 and an attached header 120. The header 120 includes one or more ports 122 to receive a terminal pin of an implantable lead 130. The lead 130 is configured to deliver pacing pulses, defibrillation shock energy, or cardioversion therapy to a heart, for example. The implantable medical device 100 can be implanted in a surgically-formed pocket in a patient's chest or other desired location. Alternatively, the pulse generator 105 can be placed in a subcutaneous pocket made in the abdomen, or in other locations.

The implantable medical device 100 generally includes electronic components 142 to perform signal analysis, processing, and control. The implantable medical device 100 can include a power supply such as a battery 150, a capacitor, and other components housed within housing 110. The implantable medical device 100 can include microprocessors to provide processing and evaluation to determine and deliver electrical shocks and pulses of different energy levels and timing for ventricular defibrillation, cardioversion, and pacing to a heart in response to cardiac arrhythmia including fibrillation, tachycardia, and bradycardia via one or more electrodes of the lead 130. The implantable lead 15 can include electrodes on a distal end to provide therapy to a body. At least one electrical conductor is disposed within the lead 15 and extends from the proximal end to the electrode. The electrical conductor carries electrical currents and signals between the pulse generator 105 and the electrode.

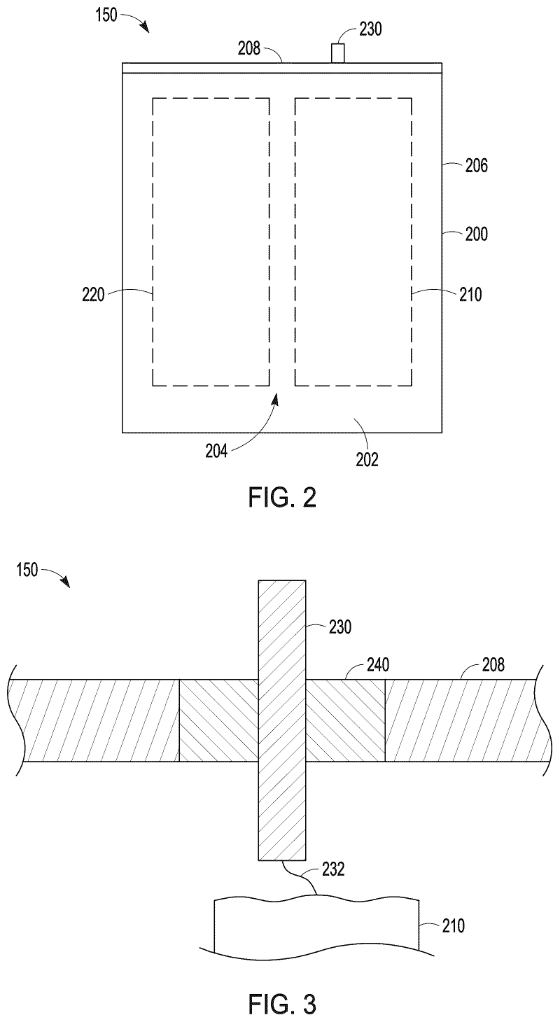

FIG. 2 shows a side view of the battery 150, in accordance with one embodiment. The battery 150 can include a metallic housing 200 defining a chamber 202 which holds a battery stack 204. In one embodiment, the housing 200 can be manufactured from a conductive material, such as stainless steel. The housing 200 can include a base 206 and a lid 208 positioned on an upper rim of base 206. The interior chamber 202 of the battery housing 200 can be filled with an electrolyte.

The battery stack 204 is shown schematically and can include different structures of electrodes, such as anodes 210 and cathodes 220. Some battery stacks 204 can include a flat stack electrode arrangement and can include a plurality of alternating anodes 210 and cathodes 220. A separator can be positioned between alternating cathodes and anodes. In other embodiments, sintered cathodes and/or anodes can be utilized. In one embodiment, one of the electrodes 210, 220 can be coupled to the housing 200 which acts as a first terminal and the other electrode can be coupled to a feedthrough terminal 230.

For example, after assembly, the cathode(s) 220 can be electrically coupled to the housing 200 and the anode(s) 210 can be coupled to the feedthrough terminal 230. The feedthrough terminal 230 can pass through the housing 200 and can be electrically insulated from housing 200. In some embodiments, these roles are reversed and the cathode(s) 220 can be connected to the feedthrough terminal 230 and the anode(s) 210) can connect to the housing 200. In some embodiments, two feedthroughs can be provided, one for the anode and one for the cathode.

In one example, the anodes 210 can be formed of a lithium layer on a collector, such as a nickel collector. The cathodes 212 can be formed of a cathode material, such as MnO₂, coated to a stainless steel wire-mesh collector.

One problem with lithium batteries is minimizing lithium cluster growth in the battery. The lithium cluster growth can initiate where electrolyte pooling is in contact with the anodic surface. In some examples, the pooling and cluster growth can form anywhere within the separator/anode assembly. For example, one area of lithium cluster growth can be located where the anodes 210 are coupled to the feedthrough terminal 230.

FIG. 3 shows a cross-section view of the lid 208 of the battery 150, in accordance with one embodiment. Here the feedthrough terminal 230 is shown coupled to the anodes 210. The feedthrough terminal 230 can be directly attached to the anodes 201 or a tab 232 can extend between the feedthrough terminal 230 and the anodes 210. As noted, in some examples, the feedthrough terminal 230 can alternatively be coupled to the cathodes.

Here, the feedthrough terminal 230 extends through a hole in the lid 208 of the battery housing. A glass insulator 240 can be positioned to hold the feedthrough terminal 230 and electrically insulate the feedthrough terminal 230 from the lid 208. In one example, the feedthrough terminal 230 can be formed of molybdenum. Molybdenum is used because molybdenum has a good CTE (co-efficient of thermal expansion) with the glass material of the glass insulator 240.

However, the feedthrough terminal 230, especially if formed of molybdenum, can corrode in the presence of water/electrolyte when subjected to ˜3V. This requires rigorous cleaning to remove electrolyte (electrolyte is hydrophilic) and subsequent hold times out of the dry room prior to inspections/yield loss. Moreover, smaller batteries use shorter feedthrough terminals, which reduces the isolation gap for solder flow during installation of the battery within the IMD housing.

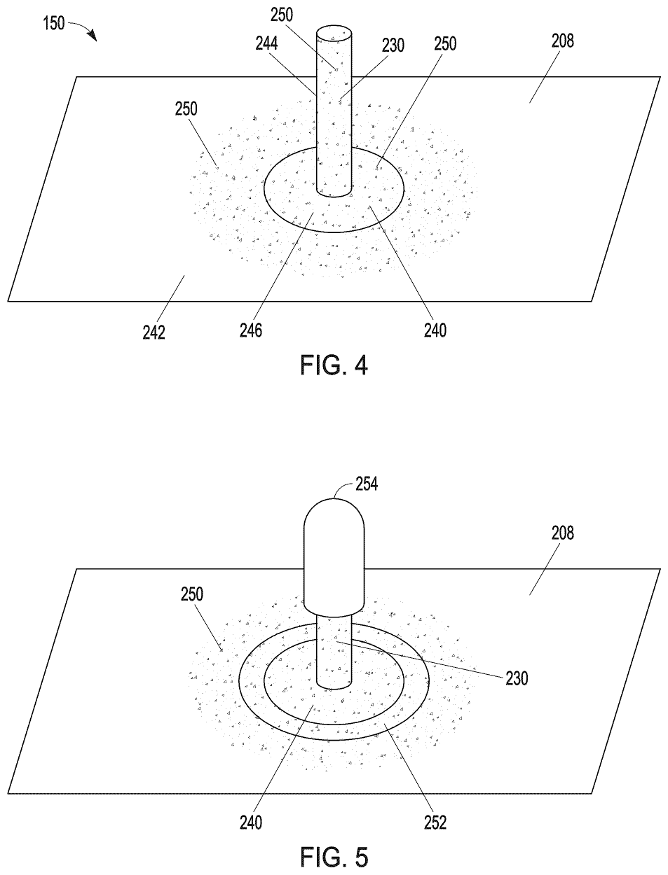

FIG. 4 shows a top perspective view of the lid 208 of the battery 150, in accordance with one embodiment. In this embodiment, at least a portion of an outside surface 242 of the lid 208 and an outer surface 244 of the feedthrough terminal 230 and an outer surface 246 of the glass insulator 240 are covered by a first layer of a chemically resistant, electrically insulative coating 250. For example, the electrically insulative coating 250 can include a layer of an aluminum oxide 250. In one example, the layer of aluminum oxide 250 can include a sputtered layer of aluminum oxide having a thickness of about 5 μm or less of aluminum oxide.

In other embodiments, other chemically resistant, electrically insulative coatings can be used. For example, the insulative coating 250 can include one or more of various electrically insulative oxides and nitrides. Some examples include oxides of elements such as Al, Si, Hf, Zr, Ti, Mg, B, Ca, Ta, Nb, Mn W, and Co and nitrides of elements such as Al & Si.

The electrically insulative coating 250, such as the layer of aluminum oxide 250, can be positioned and configured to prevent corrosion of the outer surface 244 of the feedthrough terminal. The layer of aluminum oxide 250 on the feedthrough terminal 230 does this by preventing corrosive agents (electrolyte/water) from contacting the outer surfaces of the feedthrough terminal 230. This is especially helpful if the feedthrough terminal 230 is formed of molybdenum since molybdenum is corrosive in the presence of water and electrolyte.

FIG. 5 shows a top perspective view of the lid 208 of the battery, in accordance with one embodiment. In further assembly of the battery, a polyimide tape 252 can be positioned over the glass insulator 240 and a portion of outside surface 242 of the lid 208 around the glass insulator 240. The polyimide tape 252 also covers over portions of the first layer of the electrically insulative coating 250.

A solder sleeve 254, which can be formed of a nickel gold material, can be laser welded to the outside portion of the feedthrough terminal 230 over the layer of electrically insulative coating 250. The laser weld ablates through the electrically insulative coating 250 to bond to the feedthrough terminal 230. In this situation, the electrically insulative coating 250 helps prevent any solder bridges from forming between the solder sleeve 254 and the lid 208 (when the solder sleeve is attached to the electronics within the implantable medical device) by providing electrical insulation beneath the polyimide tape 252 between the solder sleeve 254 and the lid 208.

Accordingly, applying an electrically insulative coating, such as an aluminum oxide coating, on the outer surfaces of the battery, specifically, a sputtered aluminum oxide coating on the outside surfaces of the molybdenum feedthrough terminal 230, the glass insulator 240 and the surrounding area of the lid 208 works by preventing corrosive agents (electrolyte/water) from contacting the feedthrough terminal 230, and also by increasing the electrical isolation between the solder sleeve 254 and the lid 208. The aluminum oxide (or other insulative coating listed above) serves to block any solder from reaching the lid 208 if it flows under the polyimide tape 252.

As discussed above, implantable medical devices are getting smaller, which drives a need for a higher energy density primary cell. Inactive components within the battery reduce energy density, so there is a clear benefit to reducing that volume. Currently, manufacturers use Medical Adhesive (MA) to increase the electrical spacing in the battery and as a lithium cluster mitigation. MA is an inactive component which takes up volume in the primary cell.

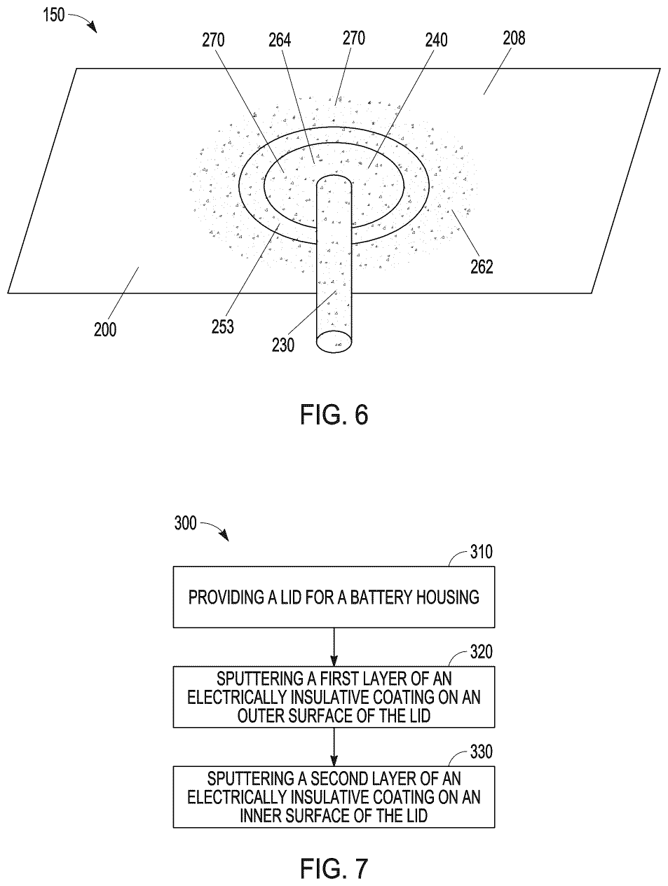

FIG. 6 shows a bottom perspective view of the lid 208 of the battery 150, in accordance with one embodiment. Here, at least a portion of an inner surface 262 of the lid 208 and an inner surface 264 of the glass insulator 240 are covered by a second layer of a chemically resistant, electrically insulative coating 270. In one example, the electrically insulting coating 270 can include a sputtered aluminum oxide coating 270. A large portion of the inside surface can be sputtered with aluminum oxide, for example. The inside portion of the feedthrough terminal 230 is not coated with the aluminum oxide.

Here, a polyimide tape 253 is positioned over inner surface 264 of the glass insulator 240 and the portion of inside surface 262 of the lid 208 around the glass insulator 240 after the aluminum oxide coating 270 has been applied.

In one example, the second electrically insulative coating 270 is positioned and configured to prevent lithium clusters within the battery housing 200, which can form both over and under the polyimide tape 253, and which can be caused by pooling electrolyte.

Specifically, an electrically insulative coating, such as sputtered aluminum oxide, on the inside surfaces (the glass insulator 240 and surrounding area of the lid 208) works by increasing the electrical isolation between the feedthrough terminal 230 and the lid 208, thus requiring a longer lithium cluster to create a short. Moreover, the aluminum oxide coating eliminates concern of trapped electrolyte between the glass insulator 240 and the polyimide tape 253, which can be a cause of a lithium cluster.

The sputtered aluminum oxide coating 270 can have a thickness of 5 μm or less. This takes up less space than the use of a medical adhesive, and is more robust, but less expensive than using MA. As noted above, other chemically resistant, electrically insulative coatings can be used. For example, the insulative coating 270 can include one or more of various electrically insulative oxides and nitrides. Some examples include oxides of elements such as Al, Si, Hf, Zr, Ti, Mg, B, Ca, Ta, Nb, Mn W, and Co and nitrides of elements such as Al &Si.

FIG. 7 shows a method of manufacturing a battery, in accordance with one embodiment.

The method (300) can include providing a lid for a battery housing (310) the lid including a feedthrough terminal extending through a lid, and a glass insulator between the feedthrough terminal and the lid; sputtering a first layer of an electrically insulative coating onto at least a portion of an outside surface of the lid (320) and an outer surface of the feedthrough terminal and an outer surface of the glass insulator; and sputtering a second layer of an electrically insulative coating on at least a portion of an inner surface of the lid (330) and an inner surface of the glass insulator.

In one embodiment, the first layer of electrically insulative coating can be positioned and configured to prevent corrosion of the outer surface of the feedthrough terminal and prevent any solder bridges from forming between the solder sleeve and the lid by providing electrical insulation between the solder sleeve and the lid. The second electrically insulative coating can be positioned and configured to prevent lithium clusters within a battery housing enclosed by the lid.

One method for physical vapor deposition (sputter) of an aluminum oxide coating can include the following procedure:

Cleaned parts are placed on fixtures and loaded into sputter equipment load lock. A vacuum is pulled and the parts are transferred into the sputter chamber. An argon/oxygen gas mixture floods the chamber and an electrical bias is initiated which creates a plasma. The plasma is directed towards an aluminum target, the impinging argon plasma causes aluminum atoms to cleave from the sputter target and energetically bound towards the surface of the part. Areas of the part exposed by the fixturing (other areas can be masked, for example) are coated with aluminum which oxidizes with energized oxygen atoms at the surface. This creates the aluminum oxide film. In one example, the first layer and the second layer of aluminum oxide can include a <5 μm layer of aluminum oxide.

EXAMPLE—Fifteen parts were coated with an aluminum oxide coating discussed above and sixty-five parts were standard parts with no coating. Of the fifteen sputter samples, seven had a coating thickness of 1.5 um sputtered aluminum oxide and eight samples had a coating thickness of 3 um sputtered aluminum oxide.

A swab was saturated with electrolyte. The saturated swab was wiped once on each test battery on the feedthrough glass and under the sleeve. The samples then sat in a standard battery shipping environment for two weeks and then were inspected for corrosion using a microscope with a minimum 10× magnification to inspect under the sleeve and on feedthrough terminal for corrosion.

Results: 100% of the fifteen aluminum oxide sputtered parts showed no corrosion after sitting in the battery shipping room for the two-week post doping period. 52.3% of the standard parts with no aluminum oxide coating had corrosion after the two weeks.

In summary, the present system incorporates a chemically resistant electrically insulative coating in select areas of electrochemical cells as a lithium cluster mitigation and to prevent molybdenum corrosion. In various embodiment the coating can include one or more of various electrically insulative oxides and nitrides. Some examples include oxides of elements such as Al, Si, Hf, Zr, Ti, Mg, B, Ca, Ta, Nb, Mn W, and Co and nitrides of elements such as Al & Si.

The sputter-coating techniques described in this discussion can substantially reduce cost and simplify manufacturing of small batteries. This present system can include depositing a very thin layer of insulative aluminum oxide onto the desired location of the battery. For example, sputtering the coating on the outside of the molybdenum pin and surrounding glass protects against corrosion and increases electrical isolation while sputtering on the glass on the inside location of the battery reduces the risk of lithium cluster formation and shorting.

Accordingly, the present system aids in the design of higher energy density cells for ICMs with a greater longevity in a smaller form factor. The present system can eliminate labor, yield, and overhead associated with using medical adhesive on the internal surfaces of the battery. Also, the present system can reduce or eliminates waste due to molybdenum feedthrough terminals becoming corroded.

In other examples, the present system can be applied to other applications. For example, for pulse generator feedthroughs to increase electrical distance between gold preforms, and in high voltage capacitor feedthroughs, for example. Additional opportunities include internal/external surfaces of various cells/batteries, and capacitors.

### Additional Notes

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. § 1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

What is claimed is:

1. A battery comprising:
an anode and a cathode enclosed within a battery housing;
a feedthrough terminal coupled to one of the anode or the cathode and extending through a lid of the battery housing; and
a glass insulator between the feedthrough terminal and the lid;
wherein an outside surface of the lid and an outer surface of the feedthrough terminal and an outer surface of the glass insulator is covered by a first layer of an electrically insulative coating.

2. The battery of claim 1, wherein at least a portion of an inner surface of the lid and an inner surface of the glass insulator are covered by a second layer of an electrically insulative coating.

3. The battery of claim 2, wherein a polyimide tape is positioned over the glass insulator and the portion of inside surface of the lid around the glass insulator.

4. The battery of claim 2, wherein the second layer of the electrically insulative coating is positioned and configured to prevent lithium clusters within the battery housing.

5. The battery of claim 1, wherein the first layer of electrically insulative coating includes a sputtered layer of aluminum oxide.

6. The battery of claim 1, further including a polyimide tape positioned over the glass insulator and a portion of outside surface of the lid around the glass insulator.

7. The battery of claim 6, further including a solder sleeve welded to the outer surface of the feedthrough terminal over the first layer of the electrically insulative coating.

8. The battery of claim 7, wherein the first layer of the electrically insulative coating is positioned and configured to prevent corrosion of the outer surface of the feedthrough terminal and prevent any solder bridges from forming between the solder sleeve and the lid by providing electrical insulation beneath the polyimide tape between the solder sleeve and the lid.

9. The battery of claim 1, wherein the battery housing is filled with an electrolyte.

10. The battery of claim 1, wherein the feedthrough terminal includes molybdenum.

11. An apparatus comprising:
an implantable housing holding electronics;
a battery located within the implantable housing, the battery including an anode and a cathode enclosed within a battery housing;
a feedthrough terminal coupled to one of the anode or the cathode and extending through a lid of the battery housing; and
a glass insulator between the feedthrough terminal and the lid;
wherein at least a portion of an outside surface of the lid and an outer surface of the feedthrough terminal and an outer surface of the glass insulator are covered by a first layer of an electrically insulative coating, and wherein at least a portion of an inner surface of the lid and an inner surface of the glass insulator are covered by a second layer of an electrically insulative coating.

12. The apparatus of claim 11, wherein a polyimide tape is positioned over the glass insulator and the portion of inside surface of the lid around the glass insulator.

13. The apparatus of claim 12, wherein the second layer of the electrically insulative coating is positioned and configured to prevent lithium clusters within the battery housing.

14. The apparatus of claim 11, wherein the first and second layers of electrically insulative coating each include a sputtered layer of aluminum oxide.

15. The apparatus of claim 11, further including a polyimide tape positioned over the glass insulator and a portion of outside surface of the lid around the glass insulator.

16. The apparatus of claim 15, further including a solder sleeve welded to the outer surface of the feedthrough terminal over the first layer of the electrically insulative coating.

17. The apparatus of claim 16, wherein the first layer of electrically insulative coating is positioned and configured to prevent corrosion of the outer surface of the feedthrough terminal and prevent any solder bridges from forming between the solder sleeve and the lid by providing electrical insulation beneath the polyimide tape between the solder sleeve and the lid.

18. A method comprising:
providing a lid for a battery housing, the lid including a feedthrough terminal extending through a lid, and a glass insulator between the feedthrough terminal and the lid;
sputtering a first layer of an electrically insulative coating onto at least a portion of an outside surface of the lid and an outer surface of the feedthrough terminal and an outer surface of the glass insulator; and
sputtering a second layer of an electrically insulative coating on at least a portion of an inner surface of the lid and an inner surface of the glass insulator.

19. The method of claim 18, wherein the first layer of the electrically insulative coating is positioned and configured to prevent corrosion of the outer surface of the feedthrough terminal and prevent any solder bridges from forming between a solder sleeve over the feedthrough terminal and the lid by providing electrical insulation between the solder sleeve and the lid, and wherein the second layer of electrically insulative coating is positioned and configured to prevent lithium clusters within a battery housing enclosed by the lid.

20. The method of claim 18, wherein the first layer and the second layer of electrically insulative coating include a <5 μm layer of sputtered aluminum oxide.
